(19) United States
(12) Patent Application Publication
(10) Pub. No.: US 2007/0198258 A1
(43) Pub. Date: Aug. 23, 2007

(54) Method and portable device for inputting characters by using voice recognition

(75) Inventors: Cheng-Shing Lai, Taipei (TW); Xiao-Long Fan, Nanking (CN); Hua-Peng Xu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/702,527

(22) Filed: Feb. 6, 2007

(30) Foreign Application Priority Data
Feb. 17, 2006 (TW) 095105394

(51) Int. Cl. G10L 15/26

(52) U.S. Cl. 704/235

(57) ABSTRACT

A method for inputting characters by using voice recognition, which is applied to a portable device, and comprises the steps of: collecting at least one external voice to convert into a voice data by a voice collection unit; receiving the voice data by a voice recognition unit; recognizing the voice data by the voice recognition unit according to a voice recognition database so as to generate a recognition result having at least one character; transmitting the recognition result to a display unit to show the recognition result in the display unit; and generating an input signal by an input unit to select a corresponding character from the at least one character of the recognition result so that only the selected character is shown in the display unit.

### FIELD OF THE INVENTION

The present invention relates to a method and a portable device for inputting character, and more particularly to a method and a portable device for inputting characters by using voice recognition.

### BACKGROUND OF THE INVENTION

Presently, daily life of human is facing an information era accompanying with advances of electronic industries day by day, and various information products are improved and developed very fast to provide convenience for human while the information products are closely related and essential for daily life of human. Following the development of novel information products, customers pay more attention to functions and qualities of the information products. Manufacturers of information products add new functions into the information products to satisfy customers' needs, such as adding functions of message transmission, telephone directory, and electronic dictionary into mobile phones. However, users must manually press existing keys on the mobile phones to input characters for executing the functions.

Following adding new functions into mobile phones day by day, new problems occur to the mobile phones. For instance, manufacturers of information products design mobile phones more compact to provide convenience for carrying, but the compact design limits size and number of keys of the mobile phones which are smaller and fewer than that of personal computers. On existing mobile phones, basic keys thereof only include numeral keys “0-9”, symbol keys “*” “#”, and two function keys, and each of these keys has at least one additional English character, phonetic symbol, or other symbol which is inconvenient and unclear to be selected and pushed for inputting characters by users. For explaining existing disadvantages of character input methods, two general character input methods are listed as following:
(1) A character input method of Multitap type: it means that each character of an English word is generally selected after pressing a predetermined key at least one time, and then the character will be correctly shown in a display device of a mobile phone for further spelling the English word. For example, when spelling an English word “student”, a user operates the mobile phone and selects an English input mode for pressing a key “4” four times while the display device of the mobile phone shows characters “p”, “q”, “r”, and “s” in turn. After waiting a predetermined time, the character “s” will be selected as a first desired character. In the same manner, pressing a key “8” one time while the display device shows character “t”. After waiting the predetermined time, the character “t” will be selected as a second desired character. Then, pressing the key “8” two times while the display device shows characters “t” and “u” in turn. After waiting, the character “u” will be selected as a third desired character. Next, pressing the key “3” one time while the display device shows characters “d”. After waiting, the character “d” will be selected as a fourth desired character. Then, pressing the key “3” two times while the display device shows characters “d” and “e” in turn. After waiting, the character “e” will be selected as a fifth desired character. Then, pressing the key “6” two times while the display device shows characters “m” and “n” in turn. After waiting, the character “n” will be selected as a sixth desired character. Next, pressing the key “8” one time while the display device shows characters “t”. After waiting, the character “t” will be selected as a seventh desired character. Finally, pressing a function key so as to finish spelling the English word “student”. Totally, the user must press 13 times on the numeral keys “7”, “8”, “3”, and “6”.
(2) A character input method of T9 intelligent type: it means that each character of an English word is automatically decided after a user presses each of their representative numeral keys one time in turn.

For example, when spelling an English word “student”, a user operates the mobile phone and presses key “7”, “8”, “8”, “3”, “3”, “6”, and “8” in turn respectively without waiting any time while the display device of the mobile phone shows characters “s”, “t”, “u”, “d”, “e”, “n”, and “t” in turn accompanying with automatic adjustment so as to correctly finish spelling the English word “student”. Totally, the user only presses 7 times on the numeral keys “7”, “8”, “3”, and “6” without waiting any time.

In another aspect, following the advances of voice recognition technologies, the voice recognition technologies are integrated into various electronic devices. Due to difference and complication between speaking of different persons, the voice recognition technologies are difficult to correctly recognize and convert into correct input signals without any error. To solve this problem, traditional electronic devices, such as computer, are provided with a voice recognition database for comparing a received voice signal with recognition information in the voice recognition database so as to increase accuracy of voice recognition. However, due to limitation of recognition speed and memory capacity of various mobile phones, accuracy of voice recognition of the mobile phones is obviously less than that of personal computers.

As described above, when using character input methods of the Multitap type or the T9 intelligent type in mobile phones, users must press several keys and spend too much input time. Further, when using the traditional voice recognition technology in mobile phones, it is limited by recognition speed and memory capacity of the mobile phones. Thus, there is a need to develop a speedy character input method to provide convenience for users to save input time when using a portable device.

### SUMMARY OF THE INVENTION

According to one aspect of the present invention is to provide a method for inputting characters by using voice recognition, which is applied to a portable device, and comprises the steps of: collecting at least one external voice to convert into a voice data by a voice collection unit; receiving the voice data by a voice recognition unit; recognizing the voice data by the voice recognition unit according to a voice recognition database to generate a recognition result having at least one character; transmitting the recognition result to an input column of a display unit to show the recognition result in the input column; and generating an input signal by an input unit to select a corresponding character from the at least one character of the recognition result for showing the selected character in an edition column of the display unit.

According to another aspect of the present invention is to provide a portable device for inputting characters by using voice recognition, which is provided with a voice collection unit for collecting at least one external voice to convert into a voice data; a memory unit having a voice recognition database; a voice recognition unit connected to the voice collection unit and the memory unit respectively, and recognizing the voice data via the voice recognition database to generate a recognition result having at least one character; a display unit connected to the voice recognition unit, and provided with an input column for receiving and showing the recognition result; and an input unit connected to the display unit, and generating an input signal to select a corresponding character from the at least one character of the recognition result so that only the selected character is shown in an edition column of the display unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a portable device for inputting characters by using voice recognition according to a preferred embodiment of the present invention;

FIG. 2 is a block diagram of a display unit of the portable device for inputting characters by using voice recognition according to the preferred embodiment of the present invention;

FIG. 3 is a flow chart of a method for inputting characters by using voice recognition according to the preferred embodiment of the present invention;

FIG. 4 is a flow chart of the method for inputting characters by using voice recognition according to the preferred embodiment of the present invention when a recognition result is shown in an input column or an edition column of the display unit; and

FIG. 5 is another flow chart of the method for inputting characters by using voice recognition according to the preferred embodiment of the present invention when the recognition result is shown in the input column of the display unit or a cue signal is shown in the display unit.

### DETAILED DESCRIPTION OF THE PREFERRED EMBODIMENTS

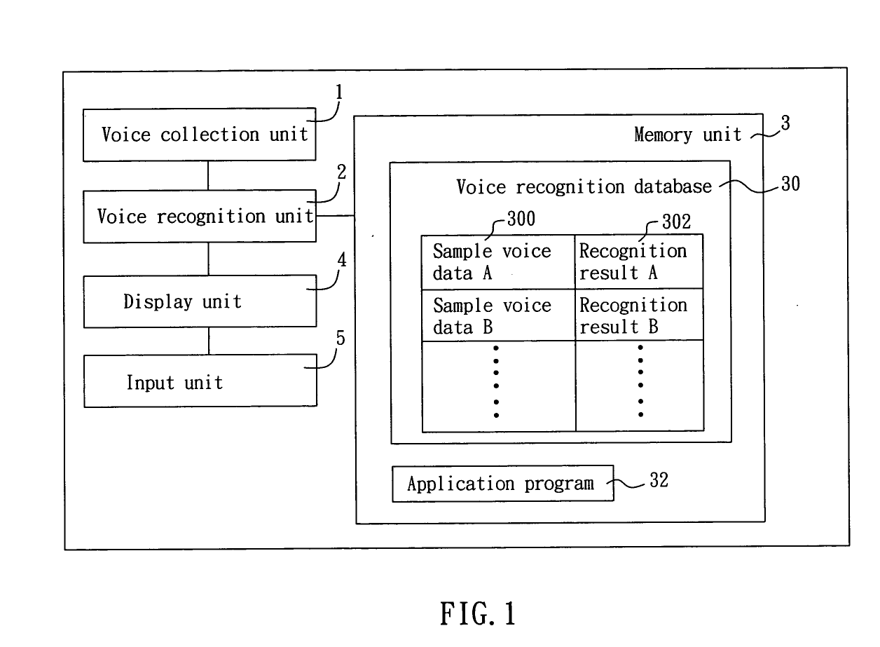

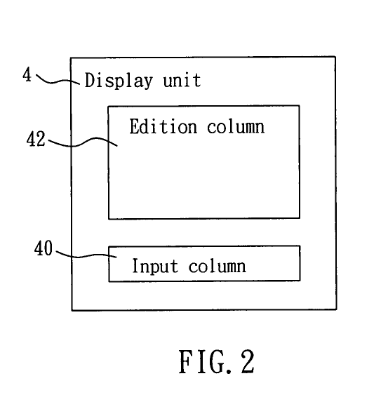

The present invention is related to a method and a portable device for inputting characters by using voice recognition. Referring now to FIG. 1, a portable device for inputting characters by using voice recognition according to a preferred embodiment of the present invention is illustrated. As shown, the portable device of the present invention comprises a voice collection unit 1, a voice recognition unit 2, a memory unit 3, a display unit 4, and an input unit 5. The voice collection unit 1 is used for collecting at least one external voice to convert into a voice data. The voice recognition unit 2 is connected to the voice collection unit 1 and the memory unit 3 respectively, and used to receive the voice data while the memory unit 3 has a voice recognition database 30 for the voice recognition unit 2 to recognize the voice data so as to generate a recognition result 302 having at least one character. The display unit 4 is connected to the voice recognition unit 2, and provided with an input column 40 for showing the recognition result 302 transmitted thereto, and an edition column 42 as shown in FIG. 2. The input unit 5 is connected to the display unit 4, and used for generating an input signal to select a corresponding character from the recognition result 302 so that only the selected character is shown in the edition column 42 of the display unit 4.

Referring still to FIG. 1, the input unit 5 of the preferred embodiment of the present invention is preferably selected from a keyboard, a mouse, or a touch panel. When the recognition result 302 is shown in the input column 40, the input unit 5 can be operated to generate an input signal. In other words, the input unit 5 is able to generate the input signal only under the display unit 4 shows the input column 40. The display unit 4 is preferably selected from a liquid crystal display (LCD), and used to show the input column 40 and the edition column 42 according to an application program 32 installed in the memory unit 3. The voice recognition database 30 has a plurality of sample voice data 300 and a plurality of the recognition results 302. Each of the sample voice data 300 is corresponding to one of the recognition results 302. The voice recognition unit 2 is used to search and select one of the sample voice data 300 which is the same as the voice data. Then, the voice recognition unit 2 is used to transmit all characters of one of the recognition results 302, which is corresponding to the selected sample voice data 300, to the input column 40 so that the characters thereof are shown in the input column 40. The voice collection unit 1 is preferably selected from a microphone. Furthermore, the memory unit 3 is preferably selected from a Read Only Memory (ROM) or a flash memory.

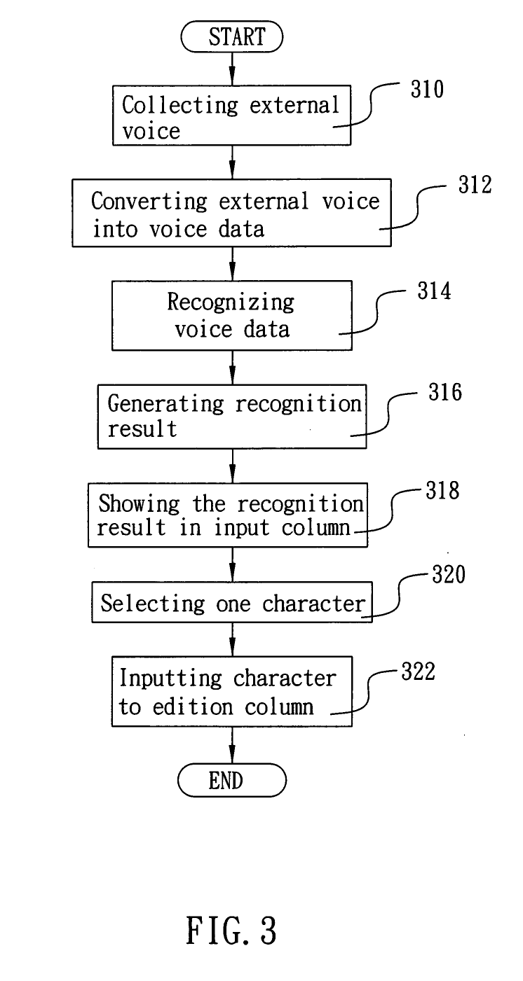

Referring now to FIGS. 1, 2, and 3, a method for inputting characters by using voice recognition according to a preferred embodiment of the present invention is illustrated. As shown, the method of the present invention is applied to a portable device, and comprises the steps of: collecting at least one external voice (step 310) to convert into a voice data by a voice collection unit 1 (step 312); receiving the voice data by a voice recognition unit 2; recognizing the voice data (step 314) by the voice recognition unit 2 according to a voice recognition database 30 so as to generate a recognition result 302 (step 316) having at least one character; transmitting the recognition result 302 to a display unit 4 to show the recognition result 302 in an input column 40 of the display unit 4 (step 318); and generating an input signal by an input unit 5 to select a corresponding character from the at least one character of the recognition result 302 (step 320) so that only the selected character is shown in an edition column 42 of the display unit 4 (step 322).

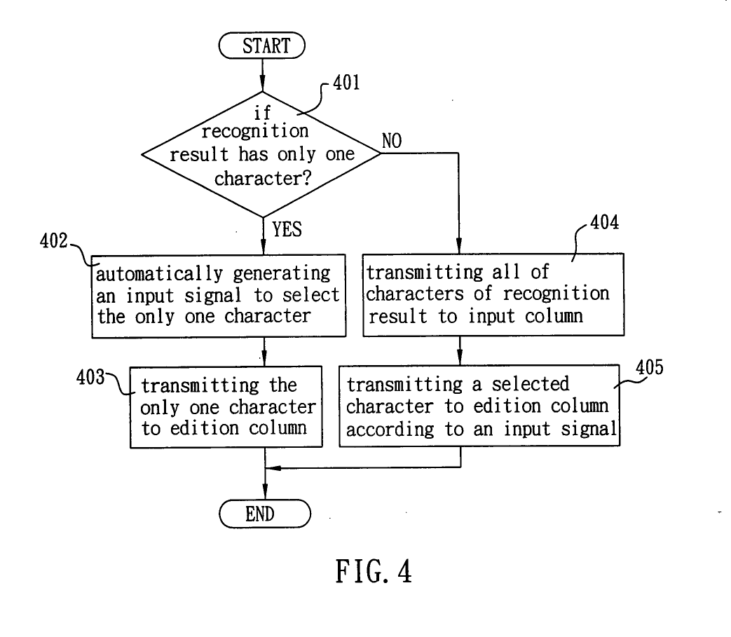

As described above, due to the recognition result 302 may have only one character, it will be inconvenient for a user to operate the input unit 5 to select the only one character. Thus, referring now to FIGS. 4, to solve this problem, after the recognition result 302 is transmitted to the input column 40 of the display unit 4, it will be more convenient to automatically transmit one of the at least one character of the recognition result 302 to the edition column 42 by the following steps:

In a step 401, determining if a recognition result 302 generated by the voice recognition unit 2 has only one character; if yes, enter a step 402; if no, enter a step 404;

In the step 402, automatically generating an input signal to select the only one character;

In a step 403, transmitting the only one character to the edition column 42 of the display unit 4 according to the automatically generated input signal;

In the step 404, transmitting all of more than one characters of the recognition result 302 to the input column 40 and show in the input column 40; and

In a step 405, transmitting a selected character to the edition column 42 of the display unit 4 according to an input signal generated by the input unit 5.

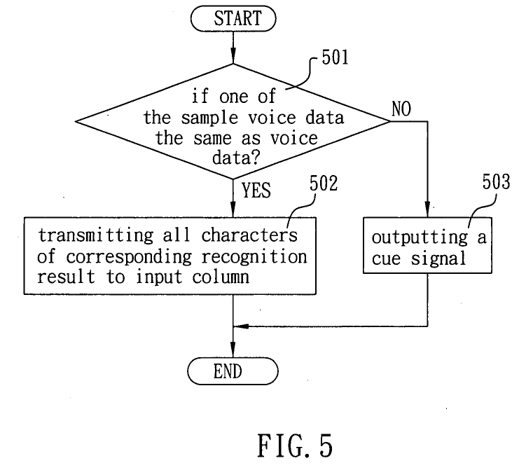

Referring now to FIG. 1 and 5, the voice recognition database 30 of one embodiment of the present invention is installed in a memory unit 3 of the portable device. The voice recognition database 30 is provided with a plurality of sample voice data 300 and a plurality of the recognition result 302. Each of the sample voice data 300 is corresponding to one of the recognition results 302. The portable device shows one of the recognition results 302 in the display unit 4 by the following steps:

In a step 501, searching the voice recognition database 300 by the voice recognition unit 2 to determine if one of the sample voice data 300 which is the same as the voice data; if yes, enter a step 502; if no, enter a step 503;

In the step 502, transmitting all characters of one of the corresponding recognition result 302 to the input column 40 of the display unit 4 according to the selected sample voice data 300 by the voice recognition unit 2; and

In the step 503, outputting a cue signal in the display unit 4 to show that the voice data is unrecognizable.

In a preferred embodiment of the present invention, an input process of the present invention is described more detail hereinafter. Firstly, the voice collection unit 1 receives a voice data of “kai”, and then the voice recognition unit 2 searches the voice recognition database 30 to find a plurality of sample voice data 300 of “kai” which are a plurality of characters shown in the input column 40 of FIG. 2. The input unit 5 is preferably selected from a keyboard. When a numeral key (such as numeral “1”) of the input unit 5 (i.e. keyboard) is pressed, the input unit 5 generates an input signal to select one of the characters (such as the character corresponding to numeral “1”), and then the selected character is inputted to an edition column 42 of the display unit 4.

As described above, the voice recognition database 30 collects all characters having similar pronunciation into a common recognition result 302 while all of the characters of the recognition result 302 are shown in the input column 40 for a user to select a numeral key corresponding to a desired character from the recognition result 302 by the input unit 5 so that the user can finish the input process quickly. In this way, it is not need to install a high-resolution voice recognition technology, which may occupy too much memory capacity, in the portable device of the present invention so as to overcome the limitation of installing a voice recognition technology in portable device in the prior art. Furthermore, in comparison with traditional character input methods, the user can presses fewer keys and spends less input time by using the portable device of the present invention.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method for inputting characters by using voice recognition, comprising the steps of:
collecting at least one external voice to convert into a voice data by a voice collection unit;
receiving the voice data by a voice recognition unit;
recognizing the voice data by the voice recognition unit according to a voice recognition database to generate a recognition result having at least one character;
transmitting the recognition result to an input column of a display unit for showing the recognition result in the input column; and
generating an input signal by an input unit to select a corresponding character from the at least one character of the recognition result for showing the selected character in an edition column of the display unit.

2. The method for inputting characters by using voice recognition as claimed in claim 1, wherein after transmitting the recognition result to the input column and showing the recognition result in the input column, further comprising the step of:
generating the input signal to select the only one character automatically when the recognition result generated by the voice recognition unit has only one character; and
transmitting the only one character to the edition column of the display unit according to the automatically generated input signal.

3. The method for inputting characters by using voice recognition as claimed in claim 1, wherein when recognizing the voice data by the voice recognition unit according to the voice recognition database, outputting a cue signal in the display unit to show that the voice data is unrecognizable if the voice recognition database has no recognition result corresponding to the voice data.

4. A portable device for inputting characters by using voice recognition, comprising:
a voice collection unit for collecting at least one external voice to convert into a voice data;
a memory unit having a voice recognition database;
a voice recognition unit connected to the voice collection unit and the memory unit respectively, and recognizing the voice data via the voice recognition database to generate a recognition result having at least one character;
a display unit connected to the voice recognition unit, and provided with an input column for receiving and showing the recognition result; and
an input unit connected to the display unit, and generating an input signal to select a corresponding character from the at least one character of the recognition result for showing the selected character in an edition column of the display unit.

5. The portable device for inputting characters by using voice recognition as claimed in claim 4, wherein said input unit is a keyboard, a mouse, or a touch panel.

6. The portable device for inputting characters by using voice recognition as claimed in claim 4, wherein said input unit is able to generate the input signal only under the display unit shows the input column.

7. The portable device for inputting characters by using voice recognition as claimed in claim 4, wherein said display unit is a liquid crystal display.

8. The portable device for inputting characters by using voice recognition as claimed in claim 4, wherein said memory unit is provided with an application program, and the display unit shows the input column and the edition column according to the application program.

9. The portable device for inputting characters by using voice recognition as claimed in claim 4, wherein said recognition database has a plurality of the recognition results and a plurality of sample voice data, each of the sample voice data is corresponding to one of the recognition results, and wherein when one of the sample voice data which is the same as the voice data, the voice recognition unit transmits all characters of one of the recognition results corresponding to the selected sample voice data to the input column.

10. The portable device for inputting characters by using voice recognition as claimed in claim 4, wherein said voice collection unit is a microphone.

11. The portable device for inputting characters by using voice recognition as claimed in claim 4, wherein said memory unit is a read only memory.

12. The portable device for inputting characters by using voice recognition as claimed in claim 4, wherein said memory unit is a flash memory.
